(19) United States
(12) Patent Application Publication
(10) Pub. No.: US 2012/0198665 A1
(43) Pub. Date: Aug. 9, 2012

(54) SEAT BELT BUCKLE

(75) Inventors: Walter Krauss, Berg (DE); Thomas Schrott, Feldafing (DE)

(73) Assignee: KEY SAFETY SYSTEMS, INC., Sterling Heights, MI (US)

(21) Appl. No.: 13/445,684

(22) Filed: Apr. 12, 2012

Related U.S. Application Data
(62) Division of application No. 12/134,269, filed on Jun. 6, 2008.

(30) Foreign Application Priority Data
Aug. 8, 2007 (DE) 202007011066.9

(51) Int. Cl. B60R 22/00

(52) U.S. Cl. 24/593.1

(57) ABSTRACT

A seat belt buckle has a frame that forms an insertion path for a buckle tongue of a seat belt. The seat belt buckle includes a locking device having a locking member for locking the buckle tongue) in the locked state. A retaining member is tensioned by a spring for securing the locking member in a locked state. An ejector for the buckle tongue is tensioned by a spring that is provided with at least one damping device to reduce the noise generated when the seat belt buckle changes from a locking state to a released state.

### FIELD OF THE INVENTION

The present invention relates to a seat belt buckle.

### BACKGROUND OF THE INVENTION

A seat belt buckle has a frame, which forms an insertion path for a buckle tongue of a seat belt, further having a locking device with a locking member for locking the buckle tongue in a locked state in a releasable manner, a retaining member tensioned by a spring for securing the locking member in the locked state, an ejector for the buckle tongue, with spring tension being applied to the ejector, and a push button for actuation of the locking device. A seat belt buckle of the type described above is known from DE 199 04 567 C1 for example.

Known seat belt buckles have a retaining member guided in longitudinal slots, wherein the retaining member is displaceable into a retaining position for securing the locking member in the locked state and into a releasing position to release the locking member. A pretensioning spring engages the retaining member and a rod-shaped guide through the pretensioning spring engages the retaining member to prevent buckling of the pretensioning spring.

Due to the sudden release of the locking and ejection springs during opening or closing of the seat belt buckle, individual components of the seat belt buckle strongly hit against each other. The noise created by the components hitting against each other is often considered unpleasant.

### SUMMARY OF THE INVENTION

A seat belt buckle according to the present invention has at least one damping device provided on the spring. Such a damping device may influence the noise generated by the seat belt buckle in two ways. It can effectively reduce the releasing speed of a spring, without affecting the spring load. By reducing the releasing speed of the springs, less acoustic noise is created during opening and closing of the seat belt buckle according to the invention. Through the selection of the damping material, which may have sound-absorbing properties, the developed sound may alternatively or additionally be absorbed and the developed noise may be further reduced.

The damping device may be sheathing of the spring wire. No costly rebuilding or additional work steps would be required during assembly of the seat belt buckles.

The damping device may be an elastic foam, wherein the desired damping properties can be adjusted by the selection of an appropriate elastic material and density of the foam. The foam may also have sound-absorbing properties.

In another embodiment, the damping device is a mechanically operating pneumatic or hydraulic damping device. Not only fixed damping properties can be adjusted on the damping device, they also may be readjusted, for example by changing the pressure inside the damping device due to modified conditions such as ambient or load conditions.

### BRIEF DESCRIPTION OF THE DRAWINGS

FIG. 1 is an exploded view of the components of a prior art seat belt buckle known from DE 199 04 567 C1.

FIG. 2 is a perspective view of the prior art seat belt buckle known from DE 199 04 567 C1.

FIG. 3 is a sectional view of another seat belt buckle in a locked state.

FIG. 4 is a sectional view of the seat belt buckle of FIG. 3 in a released state.

FIGS. 5-7 are damping devices according to the invention.

### DETAILED DESCRIPTION OF THE INVENTION

The terms “up”, “down”, “left” and “right” used in the description of the examples relate to the figures in an orientation with normal legible reference numerals and figure descriptions.

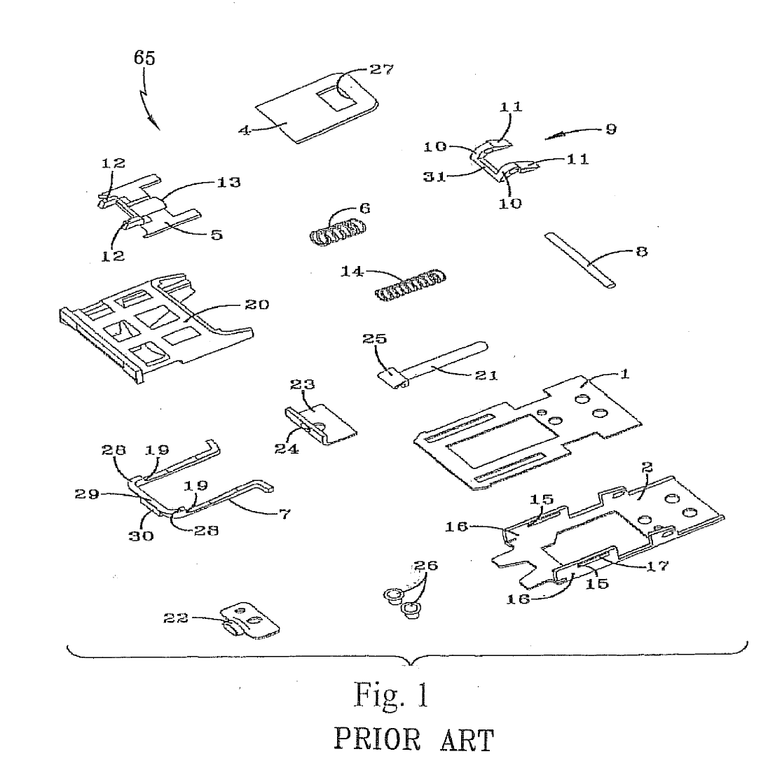

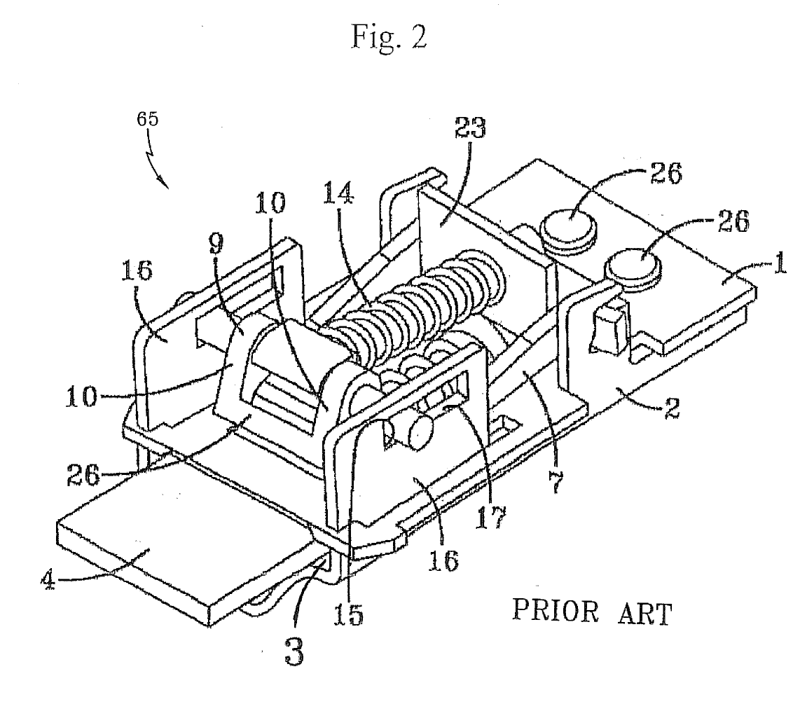

In the embodiment of the prior art seat belt buckle 65 according to DE 199 04 567 C1 shown in FIG. 2, the components of which are shown in the exploded view of FIG. 1, a locking frame comprises an upper plate 1 and a lower plate 2. The two plates 1, 2 are connected to one another by connecting pins 26. Between the upper plate 1 and the lower plate 2 a guide channel 3 is formed. In the guide channel 3 an ejector 5 is guided such that it can be displaced in a longitudinal direction. The ejector 5 is pretensioned in an ejecting direction of a buckle tongue 4 by an ejector spring 6, which is supported on a stop 22 fixed to the locking frame 1, 2. The buckle tongue 4 is connected in a common manner to a seat belt, which is not shown in detail. To lock the seat belt with the seat belt buckle, the buckle tongue 4 is inserted in the guide channel 3, wherein the ejector 5 is displaced against the force of the ejector spring 6. In this locked state a locking member 7 engages with an engaging part 30 in a locking recess 27 of the buckle tongue 4. This locked state is shown in FIG. 2.

In the locked state the locking member 7 is secured by a pin-shaped retaining member 8. The retaining member 8 is longitudinally guided in longitudinal slots 17 of the frame legs 16. The longitudinal slots 17 are oriented substantially parallel to the guide channel 3. A pretensioning spring 14, supported on a spring bracket 23 mounted to the locking frame 1, 2 engages the retaining member 8. The spring bracket 23 may be molded to the lower plate 2. The pretensioning spring is a helical compression spring 14 made of spring wire with a rod-shaped linear guide 21. The helical compression spring 14 is wound around the rod-shaped linear guide 21. The rod-shaped linear guide 21 at the front end thereof comprises an engaging part 25, which engages the retaining member 8. The rod-shaped linear guide 21 is guided at the rear end in a guide opening 24 of the spring bracket 23. In this way it is guaranteed that the pretensioning spring 14 maintains its linear shape in the respective positions of the retaining member 8 with a constant effective direction. In this embodiment, chipping or bending of the pretensioning spring 14 is prevented in all operating positions by the rod-shaped design of the rod-shaped linear guide 21, constantly providing the desired securing and retaining function of the retaining member 8.

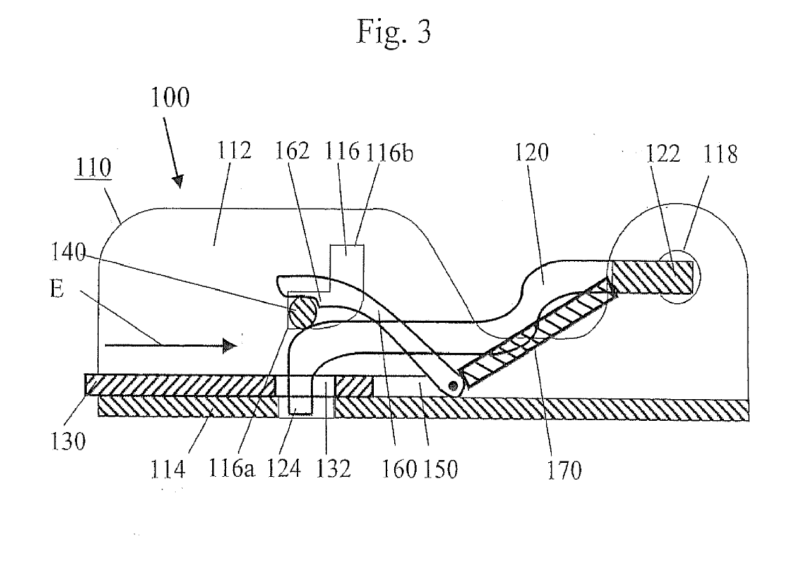

The further exemplary embodiment of a seat belt buckle 100 shown in FIG. 3 comprises a frame 110 made from a suitable metal having sufficient stability. The frame 110 has a substantially U-shaped cross-section having frame legs 112 and a flat base plate 114 connecting the frame legs 112, which are aligned to each other at approximately 90° angles. The frame legs 12 are configured identically and face one another in a mirror image form. The following description is limited to the frame leg 112 shown in FIG. 3. The description applies accordingly to the second frame leg, which is not shown.

In FIG. 3 an L-shaped recess 116 forming a sliding block guide is provided approximately in the center of the frame leg 112. A first leg section 116a of the sliding block guide 116 is oriented parallel to the base plate 114 in the buckle tongue insertion direction E of a buckle tongue 130 such that a second leg section disposed on the right end of the first leg section 116a is directed upward approximately vertically, as a result of which the leg sections 116a, 116b enclose an angle of approximately 90°. In the region of the right end of frame leg 112 a circular recess is provided forming an eye 118.

A locking member 120 extends substantially parallel to the base plate 114 of the frame 110 between the frame legs 112 and is pivotally mounted with the right end 122 thereof in the eye 118. Its width corresponds approximately to the clearance of the frame leg 112. The locking member 120 may be made of the same material as the frame 110.

A buckle tongue 130 is inserted into the seat belt buckle 100 in an insertion path extending parallel to the base plate 114 of the frame 110. In the displayed locked state of the seat belt buckle 100, the left end 124 of the locking member 120 is angled downward approximately 90° and engages a retaining opening 132 in the buckle tongue 130. In the locked state the retaining opening 132 of the buckle tongue 30 is located below the L-shaped sliding block guide 116.

In FIG. 3 a metal locking pin 140 is guided inside of the sliding block guide 116 transverse to the buckle tongue insertion direction E and parallel to the base plate 114. In the locked state of the seat belt buckle 100, the locking pin 140 assumes the locked state on the left end of the first leg section 116a of the sliding block guide 116, the section being oriented in the buckle tongue insertion direction E. The pin secures the locking member 120 in the locked state, preventing the left end 124 of the locking member 120 from sliding out of the retaining opening 132 of the buckle tongue 130 when a tensile load is applied to the seat belt during a crash.

An ejector 150 is held reversibly displaceable in the insertion path in the buckle tongue insertion direction E. On the right end thereof, a control member 160 is pivotally disposed about an axis extending transversely to the buckle tongue insertion direction E and projecting vertically up in FIG. 3. The buckle tongue 130 abuts on the left end, wherein the ejector 150 is displaced in the buckle tongue insertion direction E by the tongue when closing the seat belt buckle 100.

In FIG. 3 the control member 160 is shorter than the locking member 120. The width thereof is also less than that of the locking member 120, and it is furthermore curved in a convex manner in an upward direction. In the region of the control member 160, the locking member 120 comprises an opening not shown in detail, by which the control member 160 is disposed freely guided. The control member 160 is pivotally connected on the right lower end thereof to the ejector 150. On the bottom of the opposite left upper end of the control member 160, a downwardly directed safety nose 162 is provided, securing locking pin 140 in the locked state thereof.

Due to the low mechanical load, plastic is sufficient as the material for the ejector 150 and the control member 160.

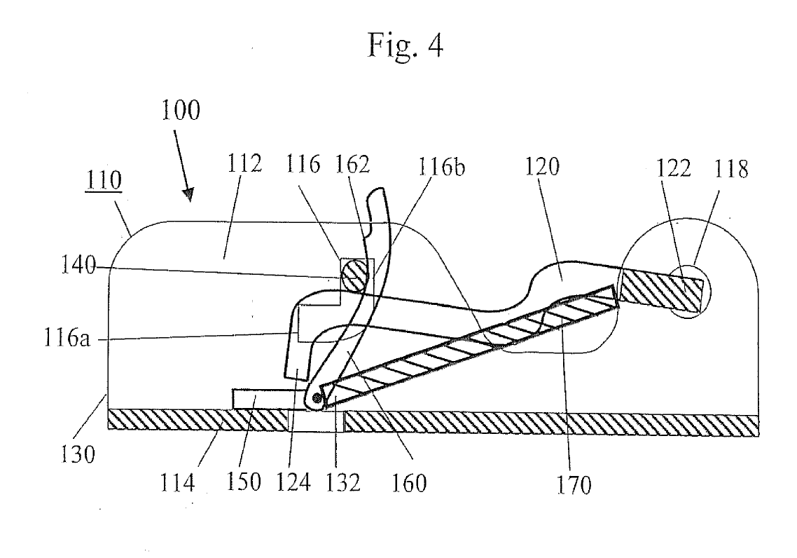

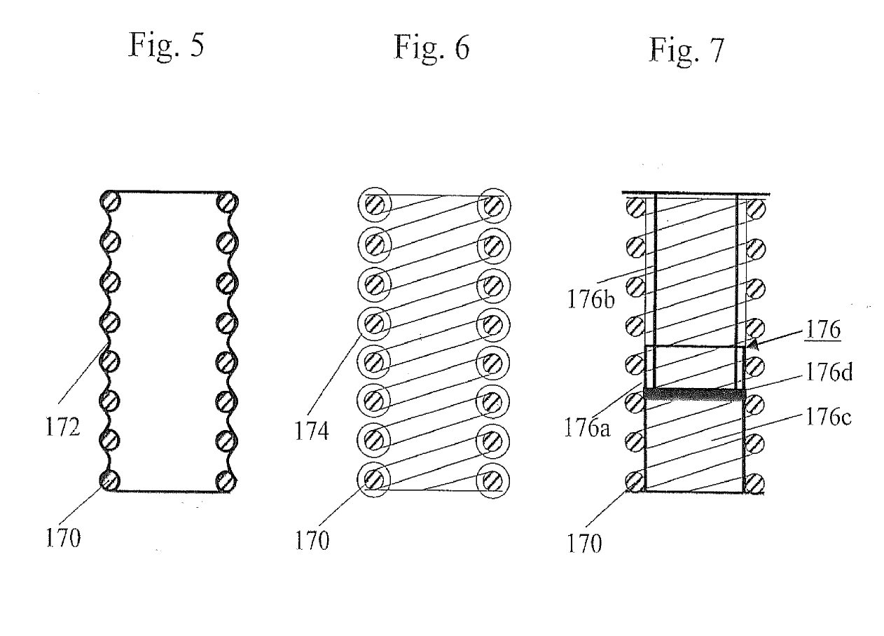

A spring 170 is shown only schematically as a bar in FIGS. 3 and 4 and will be explained later in more detail based on FIGS. 5 to 7. The spring 170 can be configured in various ways. The spring 170 is disposed with the left end thereof on the right end of the control member 160 slightly above the pivotal connection with the ejector 150. In the locked state of seat belt buckle 100 shown in FIG. 3, a force is applied to the control member 160, which holds it swiveled counter-clockwise. The right end is disposed in the region of the left end of the locking member 120. The ends of the spring 170 are pivotally connected to the control member 160 and/or locking member 120. This pivotal connection, which is not shown in more detail, can be joints connecting the ends of the spring 170 to the respective regions of the locking member 120 and the control member 160. Simple form-fit members such as clips may be also be provided, which engage the front of the spring 170, keeping it in the designated position. In the locked state illustrated in FIG. 3, the spring 170 is tensioned and applies a force on the control member 160, causing it to the secure locking pin 140 against displacement in the locked state.

Typically two separate springs are used for tensioning the locking device and the ejector. In an advantageous embodiment, the locking device and the ejector can be tensioned by a joint spring. The number of components is reduced by this design, and only one spring must be dampened according to the invention.

FIG. 4 shows the seat belt buckle 100 of FIG. 3 in a released state. In the released state, the locking pin 140 is located at the upper end of the almost vertically oriented second leg section 116b of the sliding block guide 116. The locking member 120 is swiveled upward clockwise and out of engagement with the buckle tongue 130. The previously spring-loaded ejector 150 is displaced to the left counter to the buckle tongue insertion direction E. The buckle tongue, not shown in FIG. 4, is taken out of the seat belt buckle. Due to the displacement of the ejector 150, the control member 160 is swiveled clockwise and secures the locking pin 140 in the released state. The spring 170 is not tensioned in the released state of the seat belt buckle 100.

FIG. 5 shows an exemplary embodiment of the pretensioning spring 14 from FIGS. 1 and 2 or of the spring 170 from FIGS. 3 and 4 having a first damping device 172. The damping device 172 is a shrink-fit tube which, in the shown exemplary embodiment, extends along the entire length of the spring 170. If the damping device 172 is a shrink-fit tube disposed around the spring, it can easily be retrofitted to existing springs. To attach the shrink-fit tube 172, it is pulled over the spring 170, which may be a helical compression spring, and is shrunk by suitable heat treatment such that it is non-detachably connected to the spring 170.

The spring 14,170 shown in FIG. 6 is a helical compression spring, also called a coil spring, made of spring wire. Helical compression springs are standard components and therefore available in almost any arbitrary size and may be procured with standardized properties at a low price.

The spring wire has a sheathing 174 made of a damping material, by which the damping properties of the spring are influenced. A desired damping effect may be achieved, for example, in that the sheathings of the spring windings come in contact with one another in a relaxed state or rest against one another already at a pre-load. The sheathing 174 may be applied to the spring wire prior to winding of the spring 14,170 or may be applied, for example, to the finished spring 14,170 by an immersing or spray process. The sheathing 174 may be an elastic foam, wherein the desired damping properties can be adjusted by the selection of an appropriate plastic material and density of the foam.

In addition to the damping properties, which influence the releasing speed of the spring 14, 170, the material used for the damping devices 172, 174 may also have sound-absorbing properties. A portion of the sound developed despite of damping devices 172, 174 may be absorbed by the damper material, which results in additional noise reduction. It may be advantageous to provide the damping devices only on part of the spring.

An additional noise damping effect may be achieved if the casing caps of the seat belt buckle are lined with a noise- and/or vibration-damping material. Such damping can be applied independently from the components and does not compromise their function.

The damping member 176 disposed in the spring 14, 170 of FIG. 7 is a piston/cylinder arrangement 176. The outside diameter of the cylinder 176a nearly equals the inside diameter of the spring 14, 170. The cylinder 176a is flush with the lower end of the spring 14, 170 in the illustration and extends vertically upward into the spring 14, 170. The length is selected such that it approximately corresponds to the length of the completely compressed spring 14, 170. A piston 176b is disposed above and reversibly displaceable in the cylinder 176a, whereby a cylinder space 176c is formed in the cylinder 176a. The upper end of the piston 176b is flush with the upper end of the spring 14, 170. The length of the piston 176b is selected such that the lower end thereof still projects into the cylinder 176a in the relaxed state of the spring 14, 170. A sealing member 176d is located at the lower end of the piston 176b and seals the cylinder space 176c in a pressure-tight manner in relation to the surrounding region.

The outer ends of the cylinder 176a and piston 176b have outwardly directed circumferential rims against which the ends of the spring 14, 170 are braced. Forces occurring during closing and opening of the seat belt buckle 100 act on the front ends of the cylinder 176a and piston 176b. The piston 176b, during compression of the spring 14/17 is immersed into the cylinder 176a against the force of the spring 170.

If, for example, a low pressure is present in the cylinder space 176c, a force is produced that counteracts the releasing direction of the spring 14, 170 and reduces the releasing speed. If on the other hand an overpressure is present the compression speed of the spring 14, 170 is reduced, because the overpressure present in the cylinder space 176c acts against the compression direction.

The cylinder space 176c may comprise a valve, which is not shown, by which the pressure present in the cylinder space 176c may be varied. Not only fixed damping properties can be adjusted on the damping device, they also may be readjusted, for example by changing the pressure inside the damping device due to modified conditions such as ambient or load conditions. For example, an adjustment of the damping properties of the damping device 176 may be made to changed ambient or load conditions.

The swivel connections, which are not shown in more detail, of the ends of the spring 14, 170, having the respective regions of the locking member 20 and the control member 160, may be implemented in the way described in connection with FIGS. 3 and 4.

The medium present in the cylinder space can be a gas, for example air, or a liquid, such as hydraulic oil.

If a piston/cylinder arrangement is the damping device, the damping properties thereof may also be solely based on the friction between the piston and cylinder wall. Then a pressurized cylinder space can be foregone. The friction may be advantageously influenced by a sliding member disposed between the piston and cylinder.

To place the seat belt buckle 100 in the locked state of FIG. 3, starting from the released state of FIG. 4, the buckle tongue 130 is inserted in the seat belt buckle 100 in the buckle tongue insertion direction E. The buckle tongue 130 with the right end thereof in FIG. 3 hits against the ejector 150 and displaces it in the buckle tongue insertion direction E against the force of the tensioning spring 170. By the displacement of the ejector 150 a force is applied to the control member 160 above the swivel connection to the ejector 150, whereby the control member is swiveled counter-clockwise. As a result of the force applied to the control member 160 by the tensioned spring 170, the locking pin 140 is transferred from its releasing position shown in FIG. 4 into the locked state along the sliding block guide 116. In this position the safety nose 162 engages the locking pin 140 and secures it against further displacement in the locked state.

To move the seat belt buckle 100 into the releasing position, in which the buckle tongue 130 can be removed from the seat belt buckle 100, a push-button is pushed, which is not shown. This button moves the locking pin 140 in the buckle tongue insertion direction E. Due to the L-shaped configuration of the sliding block guide 16, the locking pin 140 is moved vertically away from the locking member 120 in the first leg section 116b and the control member 160 is swiveled clockwise. As a result of the force of the tensioned spring 170, the locking member 120 is swiveled out of the locking out of engagement with the buckle tongue 130. At the same time, the buckle tongue 130 is moved out of the seat belt buckle by the ejector 150 against the buckle tongue insertion direction E.

By providing one of the damping devices 172, 174, 176 according to the invention, the releasing speed of the spring 14, 170 is reduced so far that high impact as a result of the individual components of the seat belt buckle 100 hitting against each other, such as the control member 160 and the locking pin 140, can be avoided. In addition, already produced sound is absorbed by the use of sound-absorbing materials for the damping devices 172, 174, resulting in further noise reduction.

By these measures, not only the generation of noise is reduced, but the mechanical stress of these parts is also lowered and the operation of the seat belt buckle 100 improves. The function of the seat belt buckle 100 is not compromised because only the releasing speed of the spring 14, 170 is influenced by the damping devices 172, 174, 176, but not the spring load.

Further damping alternatives are the use of plastic for certain components subject to low loads, such as the ejector 150 or the control member 160, or by the use of plastic inserts between metal components.

Due to the softer movements of the parts of the seat belt buckle 100, the generated noise changes. The noise of parts hitting fast against one another often perceived as harsh and loud becomes more quite noise due to the reduced releasing speed of the spring 170, which is perceived as more pleasant. The ease of use of a seat belt buckle 100 according to the invention is increased as well.

A seat belt buckle 100 according to the invention may combine the proposed damping devices 172, 174, 176 to optimize their effect.

The damping devices 172, 174 may be provided to only to one part of the spring 14, 170.

The sheathing 174 may be chosen such that the covered windings of the springs 14, 170 come in contact with one another in the relaxed state or already rest against each other with pre-tension.

A piston/cylinder arrangement 176 may be provided, whose damping properties are solely based on the friction between the piston 176b and the cylinder wall. A pressurized cylinder space 176c may then be foregone. The friction may be influenced by a plastic or rubber sliding member disposed between the piston 176b and the cylinder 176a.

If the ends of the spring 170 are fixed, meaning not connected in a swivel manner to the control member 160 and the locking member 120, it must be ensured that twisting of the spring 170 is given to ensure relative movements between the control member 160 and the locking member 120.

The effects and advantages of the damping devices 172, 174, 176 according to the invention on the seat belt buckle 100 according to FIGS. 3 and 4 can of course be applied to the prior art seat belt buckle 65 shown in FIGS. 1 and 2.

The pretensioning spring 14 may be provided with a damping device 172, 174, 176 according to the invention to influence the generation of noise during opening and closing of the prior art seat belt buckle 65.

With respect to the prior art seat belt buckle 65, the ejector spring 6 may also be provided with a damping device 172, 174, 176 according to the invention.

If a damping device 176 such as a hydraulic or pneumatic piston/cylinder arrangement is used in the prior art seat belt buckle 65, it may replace the rod-shaped linear guide 21 of the pretensioning spring 14.

It may be provided in a further embodiment of the seat belt buckle according to the invention that various damping devices are combined to optimize their effect.

Many changes and modifications in the above-described embodiments of the invention can, of course, be carried out without departing from the scope thereof. Accordingly, that scope is intended to be limited only by the scope of the appended claims.

1. A seat belt buckle comprising a frame that provides an insertion path for a buckle tongue of a seat belt, further comprising a locking device having a locking member for detachably locking the buckle tongue in a locked state, a retaining member tensioned by a spring for securing the locking member in the locked state, an ejector tensioned by a spring load for the buckle tongue, and the spring is provided with a damping device
wherein the spring is a helical compression spring and the damping device damping device is made of elastic plastic foam.

2.-17. (canceled)

18. The seat belt buckle according to claim 1 wherein the damping device further includes a shrink wrap around the spring.

19. The seat belt buckle according to claim 1 wherein the damping device additionally includes sheathing on the spring.

20. The seat belt buckle according to claim 1 wherein the damping device further includes sheathing on the spring and a shrink wrap about the spring.
